(19) United States
(12) Patent Application Publication
(10) Pub. No.: US 2003/0043838 A1
(43) Pub. Date: Mar. 6, 2003

(54) Transmission method allocating a time-division multiplex transmission band according to a channel band of a user packet frame

(76) Inventors: Yoriaki Shimada, Kawasaki (JP); Sumio Koseki, Kawasaki (JP); Hiroyuki Suzuki, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/015,262

(22) Filed: Dec. 12, 2001

(30) Foreign Application Priority Data
Aug. 29, 2001 (JP) 2001-260375

(51) Int. Cl. H04B 7/212

(52) U.S. Cl. 370/442; 370/446

(57) ABSTRACT

A transmission method and a transmission device are provided according to the present invention. In the method and device, a packet frame of a user is converted into a synchronous frame, and the synchronous frame is transmitted through a time division multiplex network. A time-division multiplex transmission band is allocated to the user according to a channel band of the packet frame of the user.

### BACKGROUND OF THE INVENTION

1. Field of the Invention

The present invention generally relates to a transmission method and a transmission device, more particularly, to a transmission method and a transmission device used in a TLS (Transparent LAN Service).

2. Description of the Related Art

Recently, a service referred to as a TLS (Transparent LAN Service) has been commercialized. Also, the commercialization of private line services using a LAN is also being realized. In these services, a 10/100M LAN bridge is realized in a WAN (Wide Area Network) 10, as shown in FIG. 1, and SONET-MUX's 11 and 12, which are nodes of the WAN 10, connect terminals 13 and 14 distant from each other.

Lately, networks have been required to have a broader band so as to introduce the commercialization of a gigabit-LAN-compatible TLS referred to as Gigabit Ethernet (GbE), while ongoing fierce competition between carriers (telecommunication businesses) entails further cost reductions.

FIG. 2 shows a block diagram of an example of a conventional SONET-ADM (Synchronous Optical Network Add Drop Multiplexer). In FIG. 2, ports 20a and 20b are used by a LAN of 10/100M BaseT (a LAN standardized by IEEE802.3) (not shown in the figure). MAC (Media Access Control) frames are supplied from the ports 20a and 20b, using twisted pair wires having transmission rates of 10 Mbps/10 Mbps, via LAN bridges 21a and 21b to framers 22a and 22b, respectively. In the framers 22a and 22b, the MAC frames are encapsulated by an AAL5 (ATM Adaptation Layer type 5), and are mapped to synchronous frames STS-3c (c: concatenation) and STS-1. Then, the synchronous frames STS-3c and STS-1 are switched in a SONET matrix 23, subjected to a time-division multiplexing in MUX's 24a and 24b, and sent out to transmission paths. In this example, it is assumed that the SONET transmission path is an OC-12 (Optical-Carrier-12) having a transmission rate of 50×12 [Mbps], for example. Besides, the synchronous frame STS-1 is a synchronous frame of 50 Mbps, and the transmission path OC-N and the synchronous frame STS-N each have a transmission rate of 50×N [Mbps].

There are several requirements from the current market, as follows. The first requirement is to provide, not only ports of a LAN of 10/100M BaseT, but also a TLS of a gigabit LAN. The second requirement is to make an effective use of a band by using a gigabit LAN as a user interface, and providing a user (a telecommunication business) with part of the band according to the user's needs so as to lease the remaining part of the band to other users. The third requirement is to map a MAC frame to, for example, a synchronous frame STS-3c, with omitting an encapsulation into an ATM cell and maintaining the original form of the MAC frame, for the purpose of reducing a transmission cost. The forth requirement is to realize the foregoing first to third requirements in an existing network.

In order to realize the first and third requirements of the above-mentioned four requirements at the same time, a MAC frame may be mapped to a synchronous frame STS-192c. In this case, a network has a configuration as shown in FIG. 3. In FIG. 3, MAC frames are supplied from ports 25a and 25b of a gigabit LAN to LAN bridges 26a and 26b, respectively. Then, the MAC frames are switched in a packet matrix 27, mapped to synchronous frames STS-192c in STS-192c framers 28a and 28b, and sent out to transmission paths.

However, this method does not provide a compatibility with an existing network. Specifically, an existing access network is a network in which STS-1, STS-3c, etc. are subjected to a time-division multiplexing, and therefore cannot accommodate STS-192c.

By the way, a subgroup T1X1 of the T1 committee is studying specifications of VC (Virtual Concatenation) as a technology for realizing a broadband service by using an existing transmission network. By using this technology, a SONET-ADM can have a configuration shown in FIG. 4.

Elements in FIG. 4 that are identical to the elements shown in FIG. 2 are referenced by the same reference marks. In FIG. 4, MAC frames supplied from ports 30a and 30b of the LAN to LAN bridges 31a and 31b are mapped to STS-48c and STS-24c in framers 32a and 32b and virtual-concatenation units 33a and 33b, respectively. Then, the STS-48c and STS-24c are switched in the SONET matrix 23.

However, since a band actually assigned to a user is determined according to a contract made with the user, 1 Gbps is not always necessary. In the configuration shown in FIG. 4, since the MAC frames are transmitted through the STS framers 32a and 32b before the virtual-concatenation units 33a and 33b, the user always has to use the STS-48c or STS-24c. This may result in a waste of the band if the user only requires several hundred Mbps. Additionally, the subgroup T1X1 does not study a manner to map the MAC frames to SONET frames, leaving the making of the specification at this point to each occasion.

### SUMMARY OF THE INVENTION

It is a general object of the present invention to provide an improved and useful transmission method and a transmission device in which the above-mentioned problems are eliminated.

A more specific object of the present invention is to provide a transmission method and a transmission device which are compatible with an existing network, can allocate a time-division multiplex transmission band according to users' needs, can omit an encapsulation into an ATM cell, and can realize a TLS of a gigabit LAN.

In order to achieve the above-mentioned objects, there is provided according to one aspect of the present invention a transmission method for converting a packet frame of a user into a synchronous frame and transmitting the synchronous frame by a time division multiplex network, the method comprising the step of:

allocating a time-division multiplex transmission band to the user according to a channel band of the packet frame of the user.

In order to achieve the above-mentioned objects, there is also provided according to another aspect of the present invention a transmission device comprising:

converting means for converting a packet frame of a user into a synchronous frame so as to transmit the synchronous frame by a time division multiplex network; and

transmission-band allocating means for allocating a time-division multiplex transmission band to the user according to a channel band of the packet frame of the user.

The transmission method and the transmission device according to the present invention are compatible with an existing network, and can allocate a time-division multiplex transmission band according to users' needs.

Additionally, in the transmission device according to the present invention, the converting means may map the packet frame of the user to a payload of a minimum-unit synchronous frame of a plurality of paths in bytes.

According to the present invention, a payload of a synchronous frame can be utilized effectively.

Additionally, in the transmission device according to the present invention, the converting means may map the packet frame of the user to a payload of a minimum-unit synchronous frame of a plurality of paths in units corresponding to a number of bytes of the payload.

According to the present invention, the number of times of mapping is decreased so as to enable a high-speed operation.

Additionally, in the transmission device according to the present invention, the converting means may map the packet frame of the user to a payload of a minimum-unit synchronous frame of a plurality of paths in units corresponding to a number of bytes of the packet frame.

According to the present invention, the number of times of mapping is decreased so as to enable a high-speed operation.

Additionally, in the transmission device according to the present invention, the converting means may map the packet frame of the user to the payload of the minimum-unit synchronous frame of the paths excluding a troubled path when a trouble occurs in any of the paths.

According to the present invention, when a trouble occurs in any of the paths, the troubled path can be excluded with ease.

Other objects, features and advantages of the present invention will become more apparent from the following detailed description when read in conjunction with the accompanying drawings.

### BRIEF DESCRIPTION OF THE DRAWINGS

FIG. 1 is an illustration for explaining a conventional TLS (Transparent LAN Service);

FIG. 2 is a block diagram of an example of a conventional SONET-ADM (Synchronous Optical Network Add Drop Multiplexer);

FIG. 3 is an illustration of a conventionally contrived example of a network in the future;

FIG. 4 VC is an illustration of a configuration that a SONET-ADM can comprise when using virtual concatenation;

FIG. 5 is an illustration of a configuration of an embodiment of a transmission system adopting a transmission device according to the present invention;

FIG. 6 is another illustration of the configuration of the embodiment of the transmission system adopting the transmission device according to the present invention;

FIG. 7 is a schematic diagram of a SONET-ADM device;

FIG. 8 is a block diagram of a first embodiment of a tributary interface card;

FIG. 9A is a block diagram of an embodiment of a POS generation unit;

FIG. 9B is a block diagram of an embodiment of a POS reception unit;

FIG. 10A to FIG. 10D are illustrations of a first example in which data is divided in bytes;

FIG. 11A to FIG. 11E are illustrations of a second example in which data is divided according to the number of bytes of a payload of a STS-1 frame;

FIG. 12 is a block diagram of a second embodiment of the tributary interface card;

FIG. 13A to FIG. 13E are illustrations of a third example in which data is divided in packets;

FIG. 14A to FIG. 14E are illustrations of a case where a line #2 is disconnected in the third example shown in FIG. 13A to FIG. 13E; and

FIG. 15 is a flowchart of a distribution control process performed by a monitor control interface so as to realize a transfer skip function.

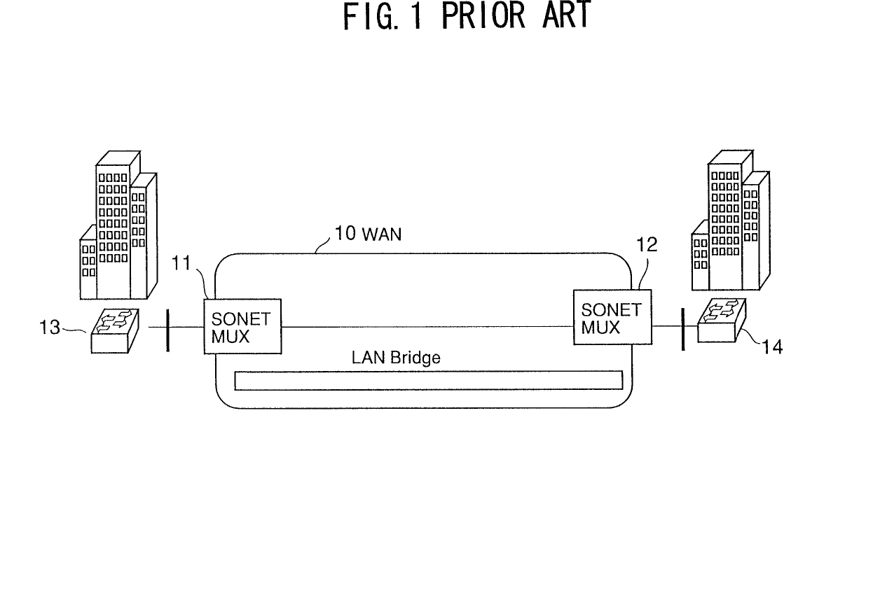

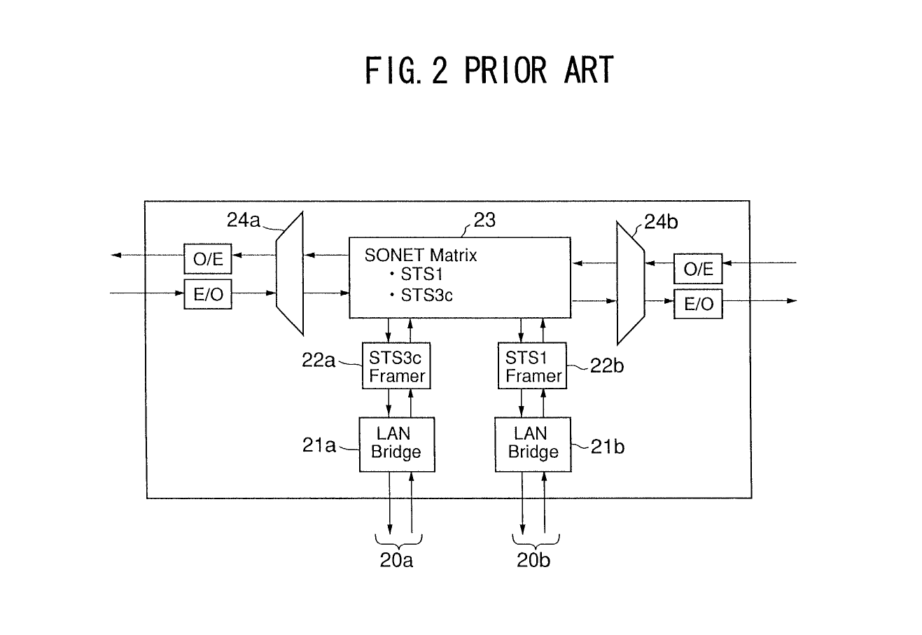

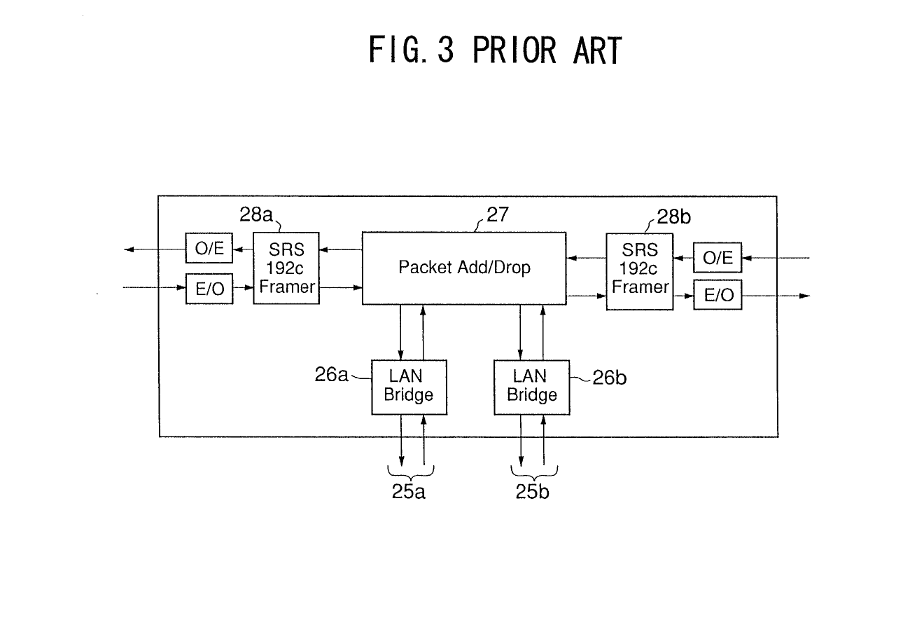

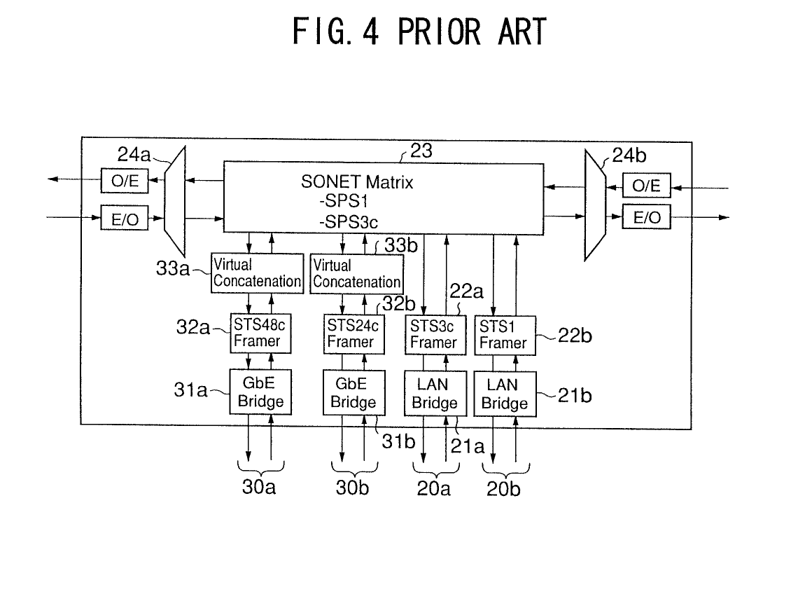

### DETAILED DESCRIPTION OF THE PREFERRED EMBODIMENTS

A description will now be given, with reference to the drawings, of embodiments according to the present invention.

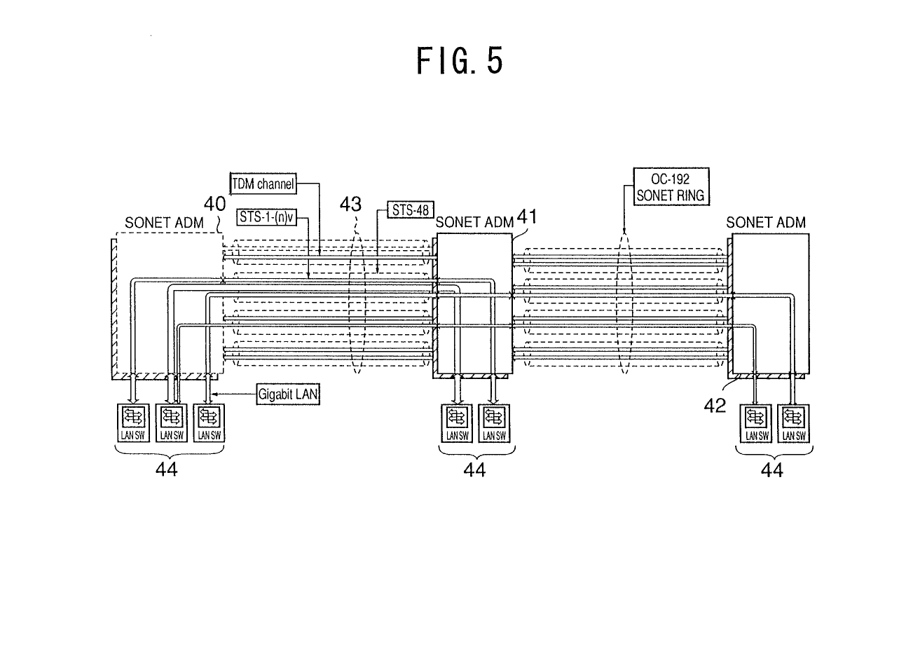

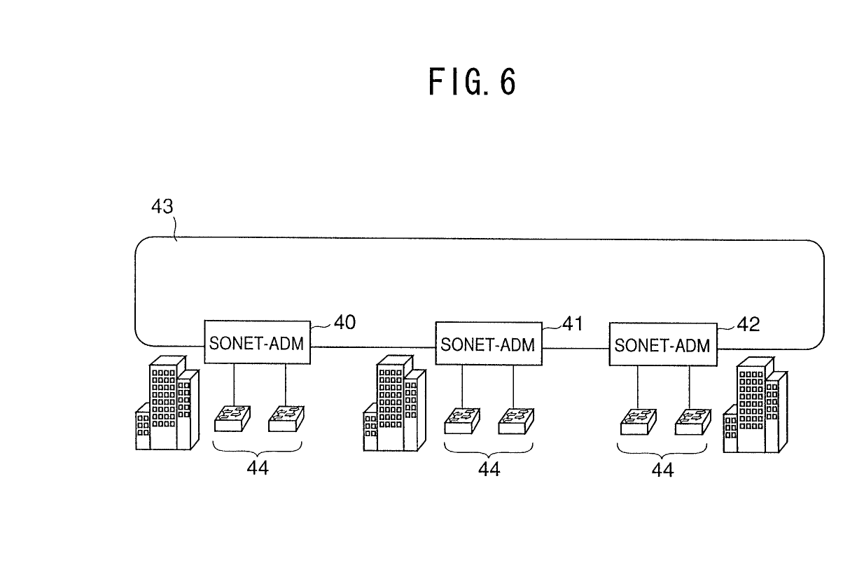

FIG. 5 and FIG. 6 show a configuration of an embodiment of a transmission system adopting a transmission device according to the present invention. SONET-ADM devices 40, 41 and 42 shown in FIG. 5 and FIG. 6 are connected by a ring-formed optical transmission path (OC-192) 43. An existing TDM (Time Division Multiplex) channel, a synchronous frame STS-48 channel, and a synchronous frame STS-Nv (v: virtual concatenation) channel are transmitted in the optical transmission path 43. Each of the SONET-ADM devices 40, 41 and 42 is connected with a switching device (LAN-SW) 44. Further, the switching device 44 is connected with a user site not shown in the figure.

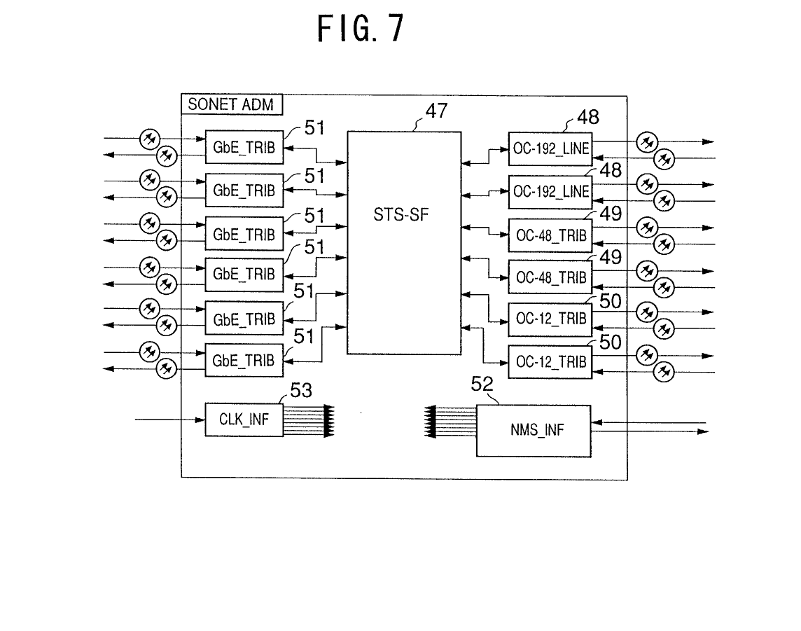

FIG. 7 shows a schematic diagram of each of the SONET-ADM devices 40, 41 and 42. In FIG. 7, the SONET-ADM device comprises a switch fabric (STS-SF) 47 in the center having synchronous frame STS-1 units, a plurality of line interface cards (OC-192_LINEs) 48, a plurality of tributary interface cards (OC-48_TRIBs) 49, a plurality of tributary interface cards (OC-12_TRIBs) 50, a plurality of tributary interface cards (GbE_TRIBs) 51. These interface cards are connected with the switch fabric 47 on a synchronous frame STS-1 basis. In addition, the SONET-ADM device comprises a monitor control interface (NMS_INF) 52 and a clock interface (CLK_INF) 53.

Each of the interface cards 48, 49 and 50 is connected to the optical transmission path 43. Each of the tributary interface cards (GbE_TRIBs) 51 is connected to the external LAN switch (LAN-SW) by 1000Base-SX prescribed by IEEE802.3z. A number of synchronous frames STS-1 corresponding to a band between each of the interface cards 48, 49, 50 and 51 and the switch fabric 47 are transmitted therebetween.

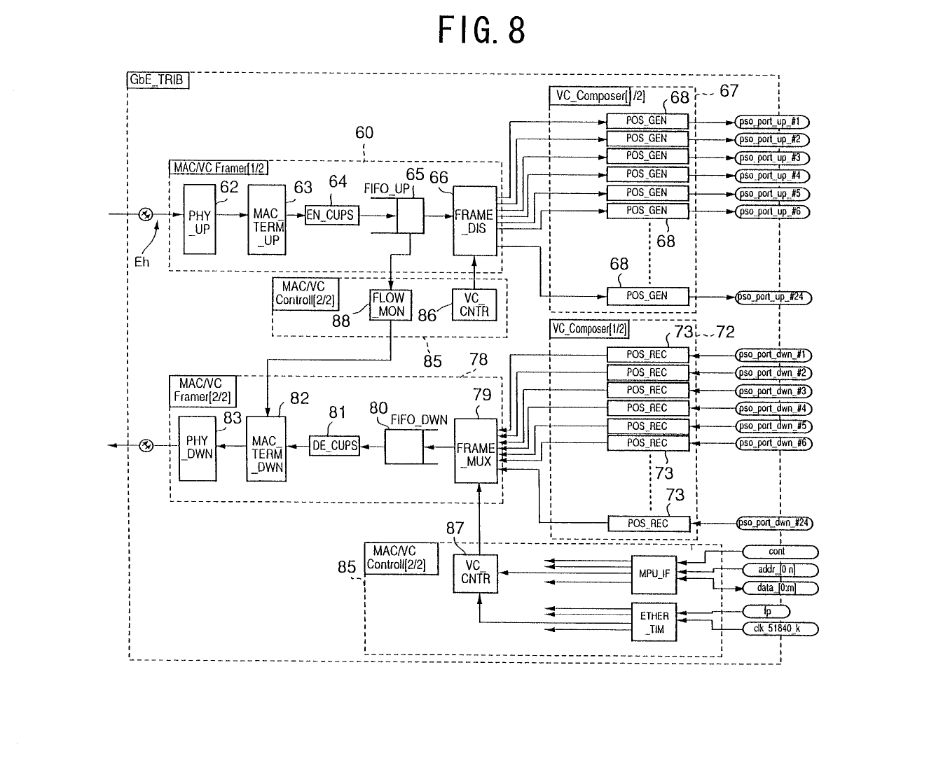

FIG. 8 is a block diagram of a first embodiment of the tributary interface card (GbE_TRIB) 51 for one port. In FIG. 8, a MAC/VC framer 60 on a side receiving a packet frame (a MAC frame) from a gigabit LAN is a block performing a termination of the packet frame (the MAC frame) and a distribution to channels.

In the MAC/VC framer 60 on the receiving side, a physical interface (PHY_UP) 62 converts an optical packet into an electric signal, a termination unit (MAC_TERM_UP) 63 terminates a packet frame, and an encapsulation unit (EN_CUPS) 64 encapsulates the packet frame into an HDLC format, i.e., adds a header and a CRC so as to divide the packet frames. In the present embodiment, the encapsulation is performed according to LAPS prescribed in ITU-T X.86 (draft version). The above-mentioned physical interface 62, the termination unit 63 and the encapsulation unit 64 form a gigabit-LAN bridge.

A buffer (FIFO_UP) 65 is a first-order buffer for the MAC frame, and has a FIFO structure. A distribution unit (FRAME_DIS) 66 disassembles the packets loaded in the buffer 65 according to channels, and transfers the packets of each channel to a VC composer (a virtual concatenation composer) 67. The buffer 65 and the distribution unit 66 form a framer.

The VC composer 67 includes POS (Packet Over SONET) generation units (POS_GENs) 68 corresponding to 24 channels (paths) so as to map each of the packets of each channel (path) to a payload of a synchronous frame STS-1. In the present embodiment, the packets can be mapped to STS-1 of 1 to 24 paths according to users' bands in the gigabit LAN. For example, if a contract with a user (a telecommunication business) stipulates 380 Mbps, in order to map the packets to STS-1 of eight paths in a provisioning, a later-described MAC/VC controller 85 sets eight as a value counted cyclically by counters 86 and 87.

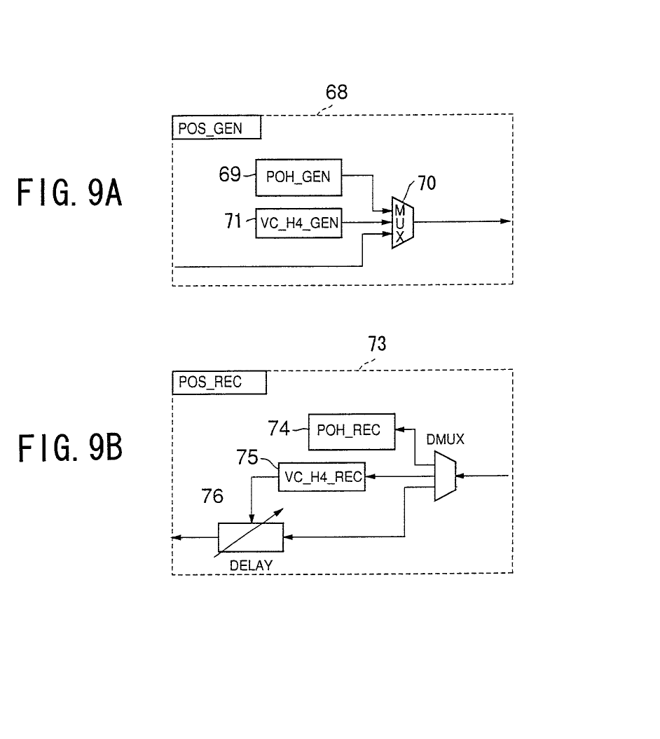

Each of the POS generation units 68 has a structure as shown in FIG. 9A, in which a POH_GEN 69 generates a pass-over head for the synchronous frame STS-1 such that the pass-over head corresponds to a position of the synchronous frame STS-1 to be sent out to the switch fabric (STS-SF) 47, and a multiplex unit (MUX) 70 adds the pass-over head to the payload of STS-1 supplied from the distribution unit 66. Also in the POS generation unit 68, a VC_H4_GEN 71 generates a H4 byte for virtual concatenation, and the multiplex unit (MUX) 71 adds the H4 byte to the payload of STS-1.

In a VC composer 72 on a side sending a packet to the gigabit LAN, a STS-1 frame received from the switch fabric (STS-SF) 47 is variable from 1 to 24 paths according to users' bands, and thus, the VC composer 72 includes POS reception units (POS_RECs) 73 corresponding to the 24 channels (paths).

Each of the POS reception units 73 has a structure as shown in FIG. 9B, in which a POH_REC 74 separates a pass-over head from the STS-1 frame, and a VC_H4_REC 75 terminates a H4 byte for virtual concatenation. The H4 bytes include a multi-frame byte, and the STS-1 frames in a particular card are synchronized by using the H4 bytes. When a skew is found, a delay unit (DELAY) 76 adjusts phases of the STS-1 frames so as to settle the difference. The received packet after the phase adjustment is transferred from each of the POS reception units 73 to a multiplex unit (FRAME_MUX) 79 of a MAC/VC framer 78 on the sending side.

In the MAC/VC framer 78, the multiplex unit (FRAME_MUX) 79 loads the packet received from a necessary channel into a buffer (FIFO_DWN) 80. A decapsulation unit (DE_CUPS) 81 reads out the packets from the buffer 80 in the order of loading, decapsulates the packet, and sends the decapsulated packet to a termination unit (MAC_TERM_DWN) 82. Thereafter, the packet is transmitted from a physical interface (PHY_DWN) 83 to the gigabit LAN as a 1000Base-SX signal prescribed by IEEE802.3z.

The MAC/VC controller 85 in a common unit sets the number of STS-1 channels according to a setting from the monitor control interface 52, and generates necessary clocks and timing signals according to a frame timing in the device.

The counters (VC_CNTRs) 86 and 87 set the number of necessary paths for virtual concatenation, and generates a timing of the disassembling and multiplexing of the distribution unit 66. A flow monitor (FLOW_MON) 88 measures a buffered amount of the buffer 65, and when the buffered amount reaches a predetermined threshold value (80 percent for example), the flow monitor 88 sends a pause signal to the MAC/VC framer 78. Thereby, the MAC/VC framer 78 transmits a pause frame in conformity to IEEE802.3x to the gigabit LAN.

As described above, according to the present embodiment, a time-division multiplex transmission band can be allocated according to a packet volume of a user (a telecommunication business) by utilizing virtual concatenation; this contributes much to increasing efficiency in packet transmission using a TDM network.

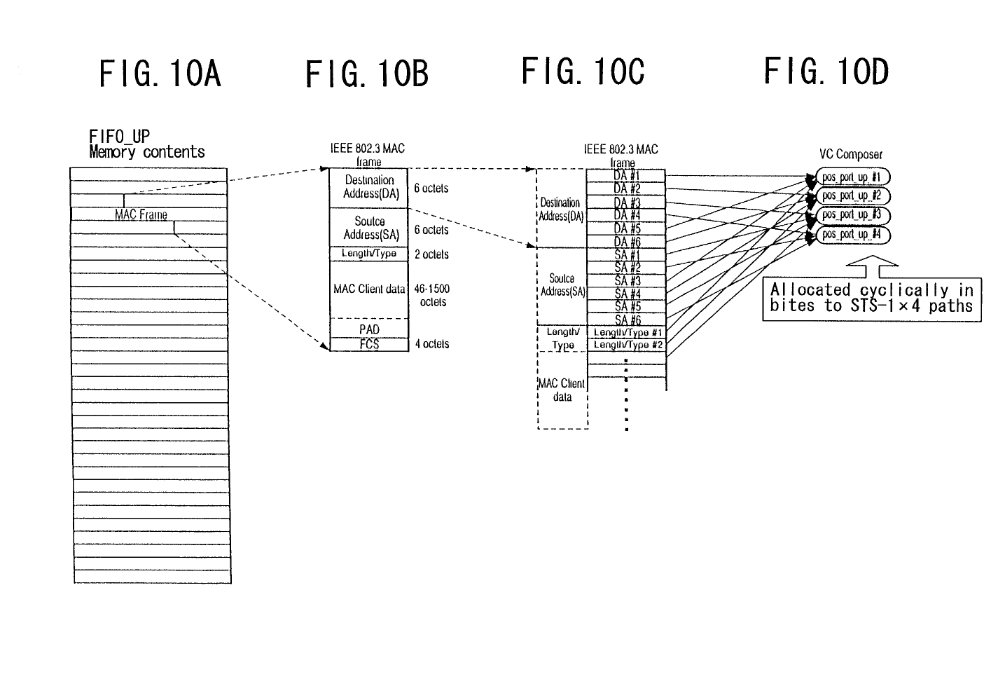

FIG. 10A to FIG. 10D are illustrations of a first example in which data is divided in bytes in the first embodiment shown in FIG. 8. It is noted that X.86 encapsulating bytes are omitted for the purpose of providing a simplified description. As shown in FIG. 10A, encapsulated MAC frames (shown in FIG. 10B) are stored successively in the buffer 65. The distribution unit (FRAME_DIS) 66 cyclically allocates data read in bytes from the buffer 65 to STS-1 frames assigned according to the value counted by the counters (VC_CNTR) 86, as shown in FIG. 10C.

When a band used by a user is equal to or less than STS-1×4 (paths), the allocated channels are transmitted to each STS-1 path in the order of #1, #2, #3, #4, #1, #2, . . . , as shown in FIG. 10D. As described above, a user's packet frame is mapped to a payload of a minimum-unit synchronous frame STS-1 in bytes so as to decrease the proportion of PADs (Packet Assembler/Disassembler) added to the payload of STS-1; thus, the payload of STS-1 can be used efficiently.

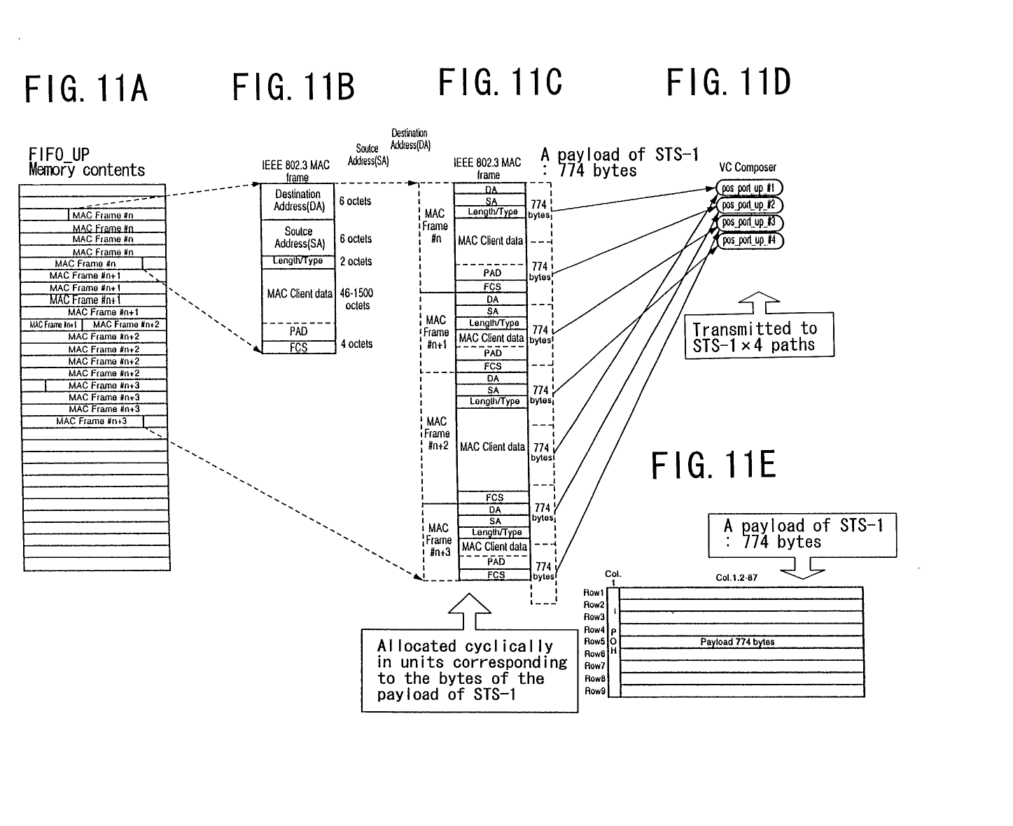

FIG. 11A to FIG. 11E are illustrations of a second example in which data is divided according to the number of bytes of a payload of a STS-1 frame in the first embodiment shown in FIG. 8. It is noted that X.86 encapsulating bytes are omitted for the purpose of providing a simplified description. As shown in FIG. 11A, encapsulated MAC frames (shown in FIG. 11B) are stored successively in the buffer 65. The distribution unit (FRAME_DIS) 66 cyclically allocates data, read in 774 byte units (the number of bytes of a payload of a STS-1 frame shown in FIG. 11E) from the buffer 65, to STS-1 frames assigned according to the value counted by the counters (VC_CNTR) 86, as shown in FIG. 11C.

When a band used by a user is equal to or less than STS-1×4 (paths), the allocated channels are transmitted to each STS-1 path in the order of #1, #2, #3, #4, #1, #2, . . . , as shown in FIG. 11D. As described above, a user's packet frame is mapped to a payload of STS-1 in 774 byte units so as to decrease the number of times to read from the buffer 65, i.e., the number of times of mapping; this enables a high-speed operation.

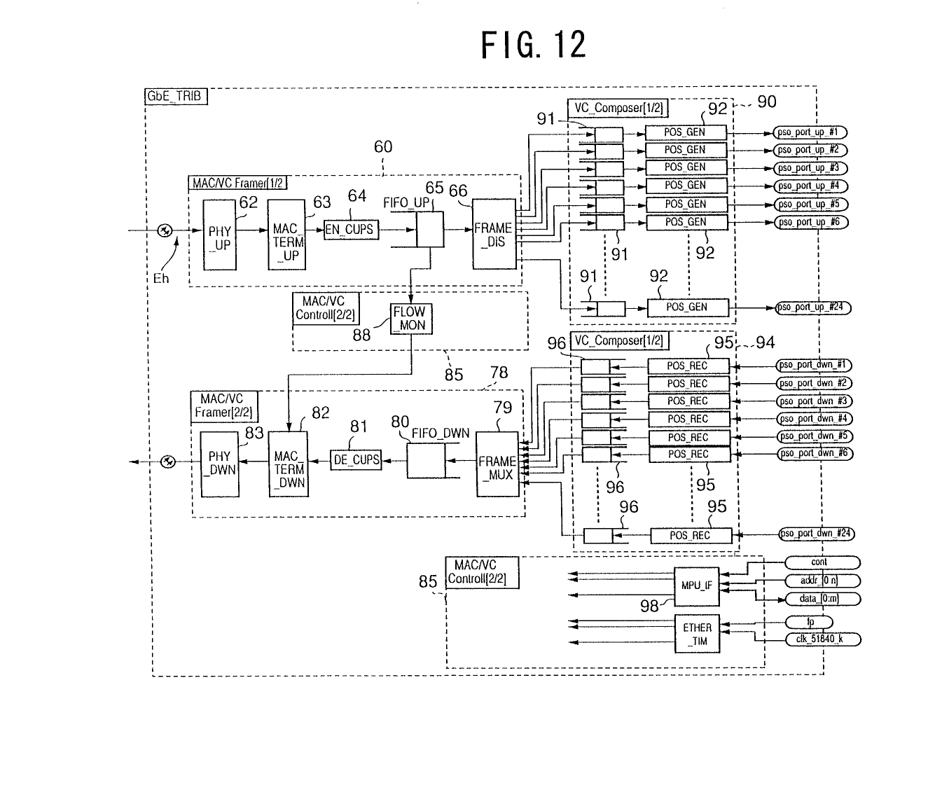

FIG. 12 is a block diagram of a second embodiment of the tributary interface card (GbE TRIB) 51 for one port. Elements in FIG. 12 that are identical to the elements shown in FIG. 8 are referenced by the same reference marks. The MAC/VC framer 60 on the side receiving a packet frame (a MAC frame) from a gigabit LAN is a block performing a termination of the packet frame (the MAC frame) and a distribution to channels.

In the MAC/VC framer 60 on the receiving side, the physical interface (PHY_UP) 62 converts an optical packet into an electric signal, the termination unit (MAC_TERM_UP) 63 terminates a packet frame, and the encapsulation unit (EN_CUPS) 64 encapsulates the packet frame into an HDLC format, i.e., adds a header and a CRC so as to divide the packet frames. In the present embodiment, the encapsulation is performed according to LAPS prescribed in ITU-T X.86 (draft version). The above-mentioned physical interface 62, the termination unit 63 and the encapsulation unit 64 form the gigabit-LAN bridge.

The buffer (FIFO_UP) 65 is a first-order buffer for the MAC frame, and has a FIFO structure. In the present embodiment, the buffer 65 has a buffer capacity equal to or more than 8 frame periods of SONET (0.125 msec×8=1 msec). The distribution unit (FRAME_DIS) 66 disassembles the packets loaded in the buffer 65 according to channels, and transfers the packets of each channel to a VC composer (a virtual concatenation composer) 90. The transfer size here is the number of bytes of a packet, up to the maximum of 6192 (=774×8) bytes. The buffer 65 and the distribution unit 66 form the framer.

The VC composer 90 includes buffers (FIFO_CH_UP) 91 and POS generation units (POS_GENs) 92 corresponding to 24 channels (paths). The packets stored respectively in the buffers 91 according to channels are mapped to payloads of synchronous frames STS-1 by the respective POS generation units 92. The POS generation units 92 have the same structure as the POS generation units 68.

In a VC composer 94 on the side sending a packet to the gigabit LAN, a STS-1 frame received from the switch fabric (STS-SF) 47 is variable from 1 to 24 (paths) according to users' bands, and thus, the VC composer 94 includes POS reception units (POS_RECs) 95 corresponding to the 24 channels. Each of the POS reception units 95 separates a pass-over head from the STS-1 frame and terminates a H4 byte for virtual concatenation so as to store the received packets in buffers (FIFO_CH_DWN) 96 corresponding to the 24 channels, as in the POS reception unit 73.

The multiplex unit (FRAME_MUX) 79 of the MAC/VC framer 78 reads out the packets from the buffers 96 corresponding to the 24 channels in the order of storing, and loads the packets into the buffer (FIFO_DWN) 80. The decapsulation unit (DE_CUPS) 81 reads out the packets from the buffer 80 in the order of loading, decapsulates the packet, and sends the decapsulated packet to the termination unit (MAC_TERM DWN) 82. Thereafter, the packet is transmitted from the physical interface (PHY_DWN) 83 to the gigabit LAN as a 1000Base-SX signal prescribed by IEEE802.3z.

The MAC/VC controller 85 in the common unit sets the number of STS-1 channels according to a setting from the monitor control interface 52, and generates necessary clocks and timing signals according to a frame timing in the device.

The flow monitor (FLOW_MON) 88 measures a buffered amount of the buffer 65, and when the buffered amount reaches a predetermined threshold value (80 percent for example), the flow monitor 88 sends a pause signal to the MAC/VC framer 78. Thereby, the MAC/VC framer 78 transmits a pause frame in conformity to IEEE802.3x to the gigabit LAN.

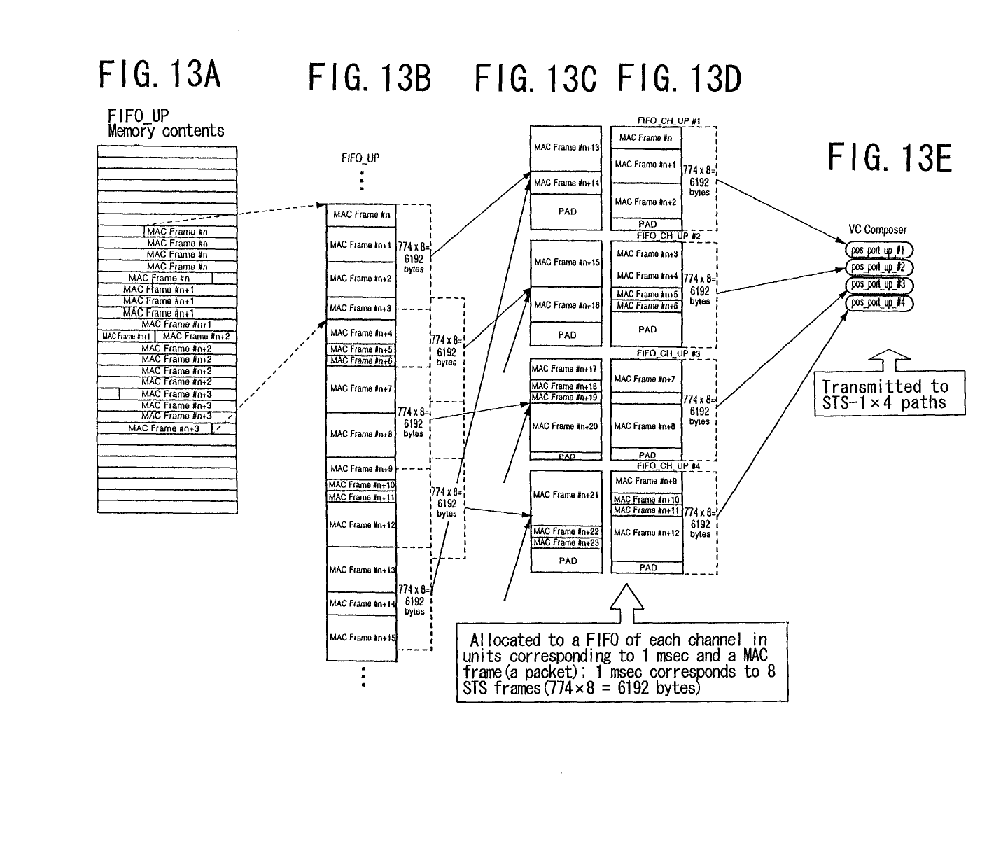

FIG. 13A to FIG. 13E are illustrations of a third example in which data is divided in packets in the second embodiment shown in FIG. 12. It is noted that X.86 encapsulating bytes are omitted for the purpose of providing a simplified description. As shown in FIG. 13A, encapsulated MAC frames (shown in FIG. 13B) are stored successively in the buffer 65. The distribution unit (FRAME_DIS) 66 cyclically stores packets, read in 6192 (=774×8) byte units from the buffer 65, in the buffers 91 assigned by the control of the monitor control interface 52, as shown in FIG. 13C. In this course, a packet that would cross over the 6192nd byte of the buffer 91 is transferred to the next STS-1 channel (path), and a PAD is inserted into the emptied bytes.

When a band used by a user is equal to or less than STS-1×4 (paths), the packets as shown in FIG. 13D are stored in the buffers 91, and are transmitted to each STS-1 path, as shown in FIG. 13E. As described above, a user's packet frame is mapped to a payload of STS-1 in packet units up to the maximum of 6192 bytes so as to decrease the number of times to read from the buffer 65, i.e., the number of times of mapping; this enables a high-speed operation.

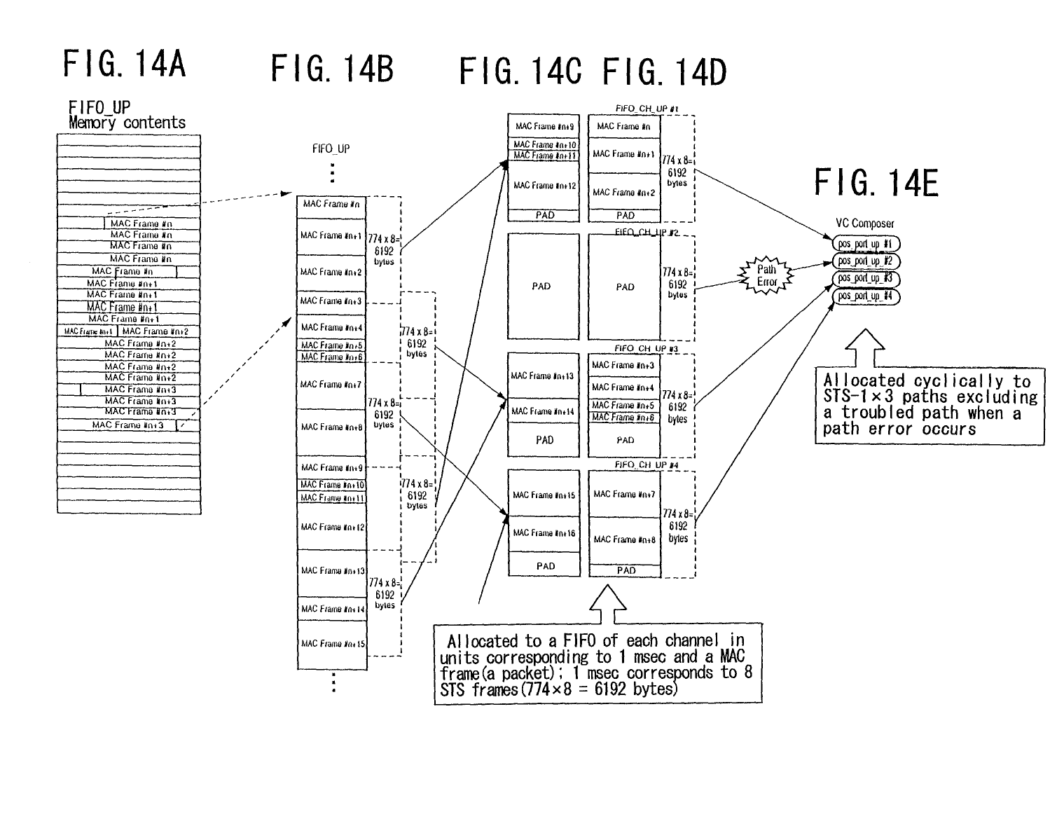

FIG. 14A to FIG. 14E are illustrations of a case where a line #2 is disconnected in the third example shown in FIG. 13A to FIG. 13E in which data is divided in packets in the second embodiment shown in FIG. 12. It is noted that X.86 encapsulating bytes are omitted for the purpose of providing a simplified description.

In this case, information (REI-P) noticing that the line #2 is disconnected is supplied to an MPU interface (MPU_IF) 98 in the MAC/VC controller 85, and then, the monitor control interface 52 controls the distribution unit 66 to skip the transfer to the buffer 91 corresponding to the line #2.

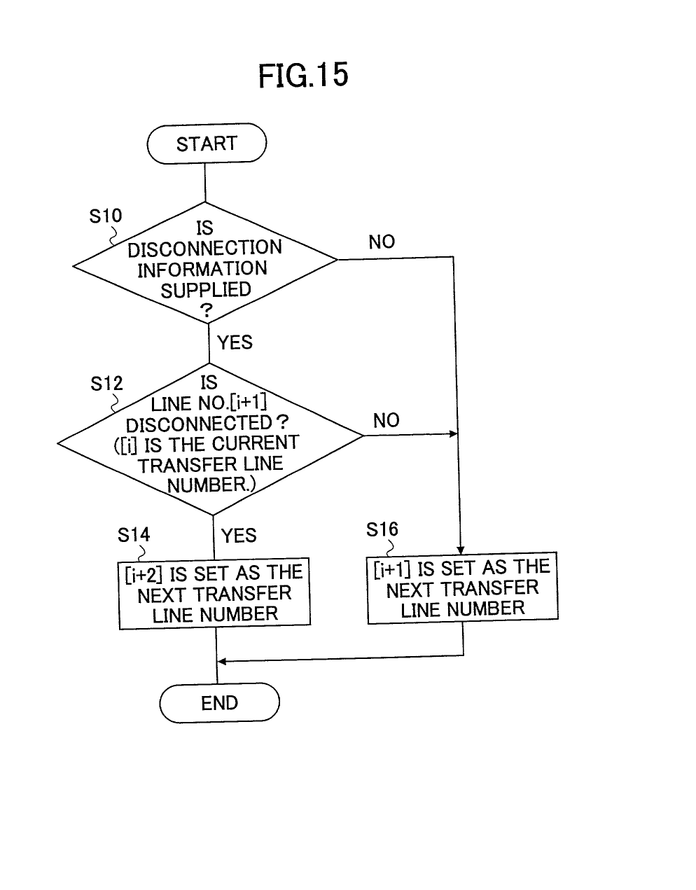

FIG. 15 shows a flowchart of a distribution control process performed by the monitor control interface 52 so as to realize the transfer skip function. This process is performed in a predetermined cycle. In step S10, it is judged whether or not the disconnection information (REI-P) concerning the STS-1 frames being used is supplied. When the disconnection information is supplied (YES in the step S10), step S12 is performed next, in which it is judged whether or not i+1 coincides with the disconnected line number, assuming that the distribution unit 66 is currently transferring packets to the buffer 91 of line number i. When i+1 coincides with the disconnected line number (YES in the step S12), step S14 is performed next, in which the next line number to transfer packets to is set to i+2. Thereafter, the process is ended.

On the other hand, when the disconnection information is not supplied (NO in the step S10), or when i+1 does not coincide with the disconnected line number (NO in the step S12), step S16 is performed next, in which the next line number to transfer packets to is set to i+1. Thereafter, the process is ended. Besides, when the line numbers of the STS-1 frames being used are #1, #2, #3 and #4, the line number is cyclically changed such that, when i is 4, i+1 is 1.

In the above-mentioned case, encapsulated MAC frames (shown in FIG. 14B) are stored successively in the buffer 65, as shown in FIG. 14A. The distribution unit 66 skips the transfer to the buffer 91 corresponding to the line #2 according to the above-described control, and cyclically stores packets in the buffers 91 corresponding to the lines #1, #3 and #4 assigned by the control of the monitor control interface 52, as shown in FIG. 14C. Besides, 6192 bytes of PADs are written in the buffer 91 corresponding to the line #2.

When a band used by a user is equal to or less than STS-1×4 (paths), the packets as shown in FIG. 14D are stored in the buffers 91, and are transmitted to each STS-1 path, as shown in FIG. 14E. As described above, since a user's packet frame is mapped to a payload of STS-1 in the packet units up to the maximum of 6192 bytes, a troubled path can be excluded with ease.

By the way, STS-1 includes a far-end error (REI-P) in the pass-over head (POH), and when the far-end error is detected on the side transferring STS-1, as described above, the distribution unit 66 skips the packet transfer to the corresponding STS-1. In this case, in order to equalize the numbers of STS-1 channels (paths) on the transferring and receiving sides, the monitor control interface 52 controls the multiplex unit (FRAME_MUX) 79 on the receiving side to skip the transfer from the buffer 96 corresponding to the line #2 so as no to multiplex the packets.

Additionally, although the above-described embodiments set forth the virtual concatenation realized by a gigabit LAN and STS-1 up to 24 paths, the present invention can be achieved also by a 10/100M LAN and a virtual concatenation of VT (Virtual Tributary) for mapping various asynchronous low-speed signals to STS-1 or a payload of STS-1.

Further, although the above-described embodiments take a SONET (Synchronous Optical Network) as an example of a TDM network, an SDH (Synchronous Digital Hierarchy) can replace the SONET.

Besides, the monitor control interface 52 and the MAC/VC controller 85 function as transmission-band allocating means, and the buffers 65 and 80, the distribution unit 66, and the multiplex unit 79 function as converting means.

The present invention is not limited to the specifically disclosed embodiments, and variations and modifications may be made without departing from the scope of the present invention.

The present application is based on Japanese priority application No. 2001-260375 filed on Aug. 29, 2001, the entire contents of which are hereby incorporated by reference.

What is claimed is:

1. A transmission method for converting a packet frame of a user into a synchronous frame and transmitting said synchronous frame by a time division multiplex network, the method comprising the step of:
allocating a time-division multiplex transmission band to said user according to a channel band of said packet frame of said user.

2. A transmission device comprising:
converting means for converting a packet frame of a user into a synchronous frame so as to transmit said synchronous frame by a time division multiplex network; and
transmission-band allocating means for allocating a time-division multiplex transmission band to said user according to a channel band of said packet frame of said user.

3. The transmission device as claimed in claim 2, wherein said converting means maps said packet frame of said user to a payload of a minimum-unit synchronous frame of a plurality of paths in bytes.

4. The transmission device as claimed in claim 2, wherein said converting means maps said packet frame of said user to a payload of a minimum-unit synchronous frame of a plurality of paths in units corresponding to a number of bytes of said payload.

5. The transmission device as claimed in claim 2, wherein said converting means maps said packet frame of said user to a payload of a minimum-unit synchronous frame of a plurality of paths in units corresponding to a number of bytes of said packet frame.

6. The transmission device as claimed in claim 5, wherein said converting means maps said packet frame of said user to the payload of the minimum-unit synchronous frame of the paths excluding a troubled path when a trouble occurs in any of said paths.

7. The transmission method as claimed in claim 1, wherein said packet frame of said user is transmitted through a gigabit LAN.

8. The transmission method as claimed in claim 1, wherein said time division multiplex network is a SONET (Synchronous Optical Network).

9. The transmission device as claimed in claim 2, wherein said packet frame of said user is transmitted through a gigabit LAN.

10. The transmission device as claimed in claim 2, wherein said time division multiplex network is a SONET (Synchronous Optical Network).
